(19) United States
(12) Patent Application Publication
(10) Pub. No.: US 2009/0191393 A1
(43) Pub. Date: Jul. 30, 2009

(54) ENVIRONMENT-FRIENDLY CARD

(76) Inventor: Chia Ching LU, Taipei Hsien (TW)

Correspondence Address: Chia Ching LU, 235 Chung - Ho Box 8-24, Taipei, TW

(21) Appl. No.: 12/019,634

(22) Filed: Jan. 25, 2008

(51) Int. Cl. B32B 7/02; C08G 63/00; B32B 27/08

(52) U.S. Cl. 428/220; 428/339; 428/497; 528/271

(57) ABSTRACT

An environment-friendly card is disclosed in the invention, characterized in that a card of a predetermined thickness is fabricated from using a predetermined proportion of polylactic acid-containing composite materials; the card may be applied for multiple purposes due to the flexibility, physical property, and mechanical property of the decomposable composite materials, and may replace petrochemistry polymers that are used to make conventional cards. The decomposable composite materials may decompose naturally or be burned in an incinerator and only gives off water and carbon dioxide after disposal, and is non-polluting because the composite materials may be recycled. As a result, the card may alleviate the problem of environmental pollution and thus is environment-friendly.

### FIELD OF THE INVENTION

The invention relates to environment-friendly cards, and more particularly to an environment-friendly card made of decomposable materials.

### DESCRIPTION OF PRIOR ART

The problems resulted from the petrochemistry polymer that is used to make various plastic cards and containers have worsened steadily, such as that the raw material (petroleum) is running out, the incineration of discarded petrochemical products creates gases that lead to global warming, and the poisonous substances that remains after burning petrochemical products causes grave consequences on human health and ecological chains, which means the pollutants may not be disposed of in landfills.

In Taiwan Patent No. 593532, “A Decomposable Thermal Plastic Material and Fabrication Method Thereof”, a decomposable thermal plastic material has been disclosed, comprising: a 15 wt % to 35 wt % of polycaprolactone, a 65 wt % to 85 wt % of polyethylene or copolymers thereof, and a coupling agent of ethene-ethylene methacrylic acid that takes up 8 to 12 phr % of polycaprolactone, polyethylene or copolymers thereof, so as to fabricate a decomposable thermal plastic in which the polycaprolactone is allowed to combine with a major proportion of petrochemistry polymer to form decomposable polymer.

Referring to FIGS. 1 to 3, when comparing known decomposable polymers (like polyhydroxybutyrate, polycaprolactone, aliphatic polyesters, or polylactic acid) with the petrochemistry polymer, the decomposable polymers may be buried in landfills and allowed to decompose in any natural environments, which subsequently breaks down into water and carbohydrates that may be recycled. Therefore, the decomposable polymers do not generate pollutants that cause environmental damage or require burning for decomposition, which makes the decomposable polymers an ideal substitute for the petrochemistry polymers.

As a result, it has been attempted to fabricate a multi-purpose composite material from using polylactic acid resin (extracted from plants like corn starch, sugar cane, yam, and potato) and polycaprolactone, and then subject the polylactic acid composite material that has similar flexibility and transparentness to that of petrochemistry polymers to further processing to fabricate a card with a thickness. As shown in FIG. 4, the polylactic acid composite material may replace the petrochemistry polymers (such as PVC and PE) used for making conventional cards and does not cause any harm to the environment.

### SUMMARY OF THE INVENTION

An environment-friendly card is disclosed in the invention, characterized in that a card of a predetermined thickness is fabricated from using a predetermined proportion of plastic materials and polylactic acid resin composite materials; the card may be applied for multiple purposes due to the flexibility and transparentness of the polylactic acid resin composite materials, and may replace PVC used for making conventional cards. The polylactic acid resin composite materials may decompose in natural environments into water and carbon dioxide after disposal, and is non-polluting because the composite material may be fermented and recycled. As a result, the composite material may alleviate the problem of environmental pollution and thus is environment-friendly.

The structure and the technical means adopted by the present invention to achieve the above and other objectives can be best understood by referring to the following detailed description of the preferred embodiments and the accompanying diagrams.

### BRIEF DESCRIPTION OF DRAWINGS

FIG. 1 is a diagram that shows the CO₂ emission of PLA.

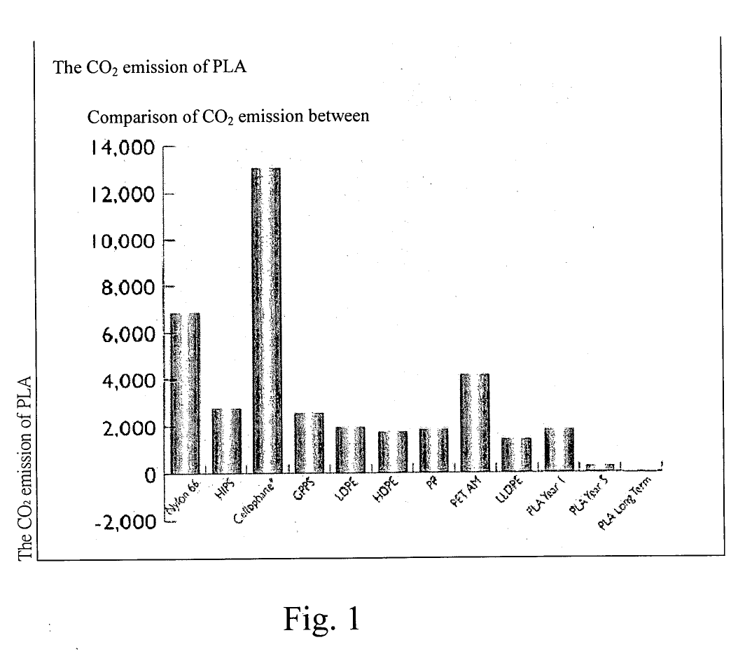

FIG. 2 is a diagram that shows the lower power consumption of PLA.

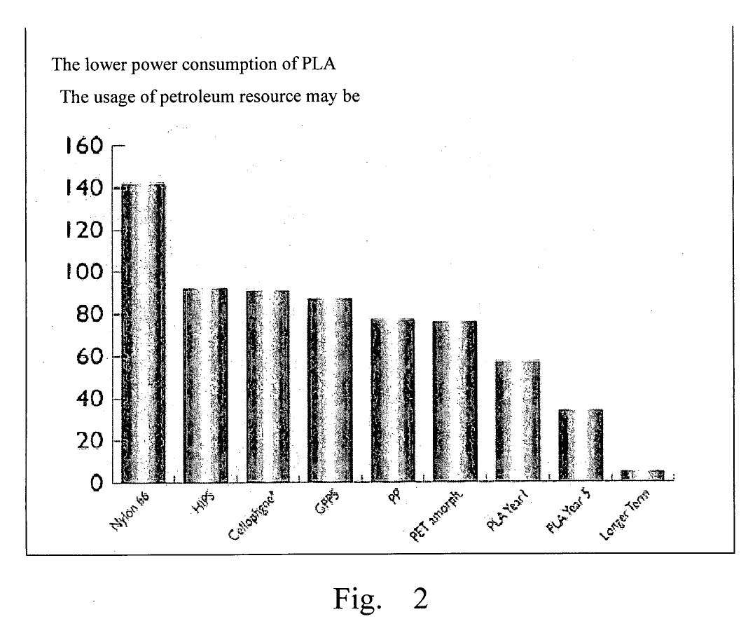

FIG. 3 is a diagram that shows the steps in the decomposition of the PLA products in the compost.

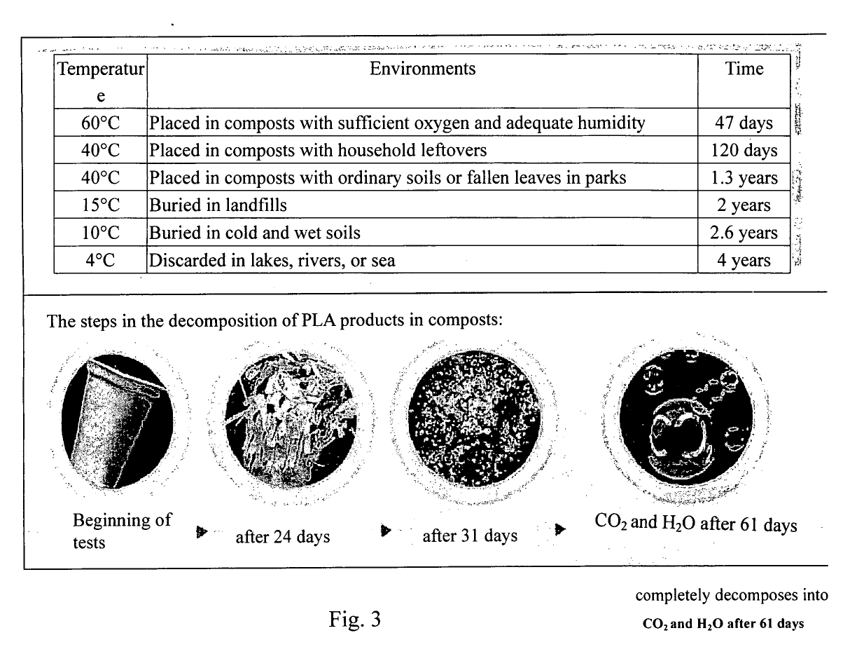

FIG. 4 is a schematic view that shows an assembly of components from the prior arts.

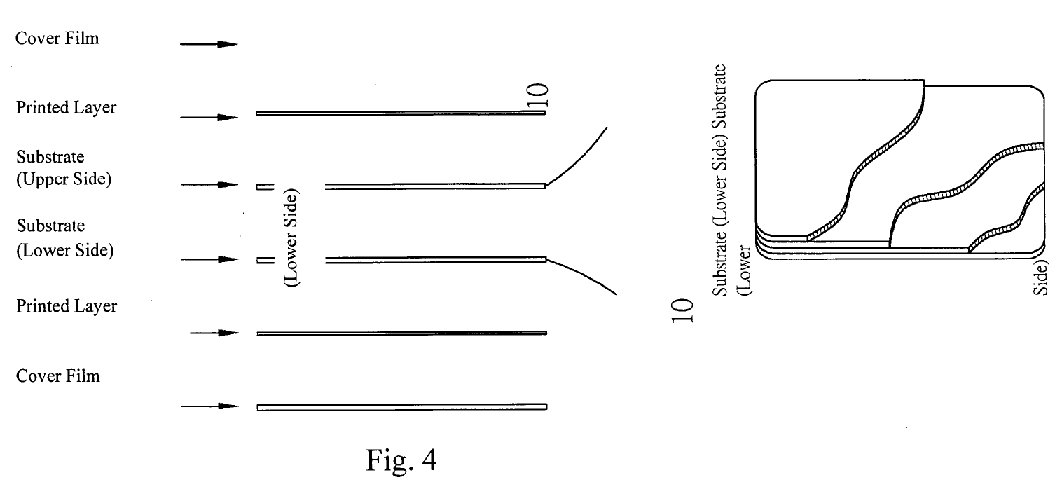

FIG. 5 is a schematic view that shows an assembly of components according to the invention.

FIG. 6 is a diagram that shows the test of vapor permeability at a constant temperature for the surfactants of the invention.

FIG. 7 is a diagram that shows the potential difference between the montmorillonite and polyimide as indicated by X-ray diffraction.

### DETAILED DESCRIPTION OF PREFERRED EMBODIMENTS

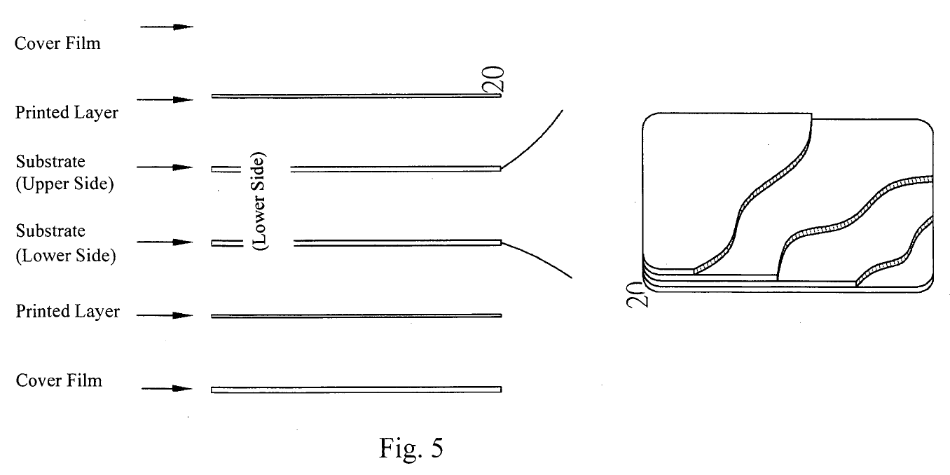

Referring to FIG. 5, an environment-friendly card has been proposed in the invention, characterized in that the environment-friendly card is comprised of a predetermined proportion of polycaprolactone (PCL) and polylactic acid (PLA) resin composite materials. It is disadvantageous to fabricate the card from only polylactic acid because this could lead to biological hydrolysis of the card, which lowers the coefficient of friction thereof and results in insufficient flexibility, while it also causes the final product to become blurry during fabrication thereof. The main factor for this is because the molecules in the polylactic acid material are distributed randomly and non-crystallized at low temperature (under 50° C.), and light may pass through the non-crystallized molecules; whereas when the polylactic acid material is heated and polymerized to a solid state, the non-crystal molecules of polylactic acid start to move and gradually become crystallized; when a threshold in temperature is reached (approximately 70° C.), the crystallization of molecules also increases and subsequently reflects the light away, which reduces the transparentness thereof and causes the final products to appear blurry. Moreover, in products fabricated using prior arts such as credit cards, sensor cards, smart cards, and cards of general purpose, a card is laminated with a combination of circuitry substrates, printing materials, and absorption materials thereon. If the card is fabricated using only polylactic acid materials, it could readily become worn out and inflexible, and easily damaged from bending. Therefore, the basic elasticity and flexibility of cards made of polylactic acid materials are worse than the cards made of petrochemistry polymers.

Therefore, an environment-friendly card comprising a predetermined proportion of polycaprolactone and polylactic acid resin composite materials has been proposed in the invention, which has properties similar to general petrochemistry polymers and is decomposable; a preferred embodiment of the invention is provided for the purpose of illustration:

It has been known that products made of polylactic acid have excellent physical and mechanical properties but inadequate flexibility, while products made of polycaprolactone have decent flexibility but low mechanical strength and melting point. By combining polylactic acid and polycaprolactone, an environment-friendly card of the invention is made of decomposable materials comprising:

a main substrate, which is a polylactic acid resin composition and may be extracts from plants (such as corn starch, sugar cane, yam, and potato); it is formed as a powder after the processes of separation, grinding, and drying; the composition of the main substrate comprises particles of approximately 5-10 nm in diameter;

an auxiliary substrate, which may be a polycaprolactone resin and a preferable proportion thereof is 10-15 wt % of the main substrate;

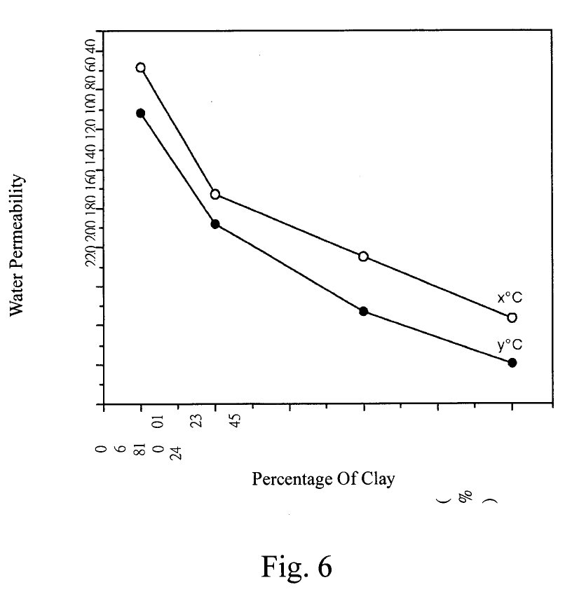

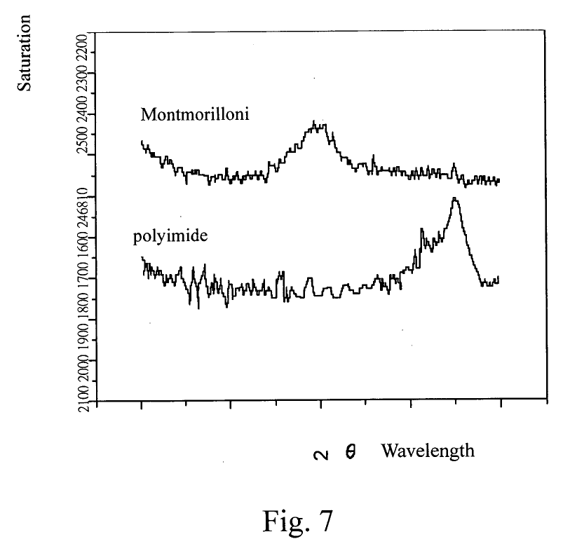

a surfactant, which is a montmorillonite added with lactic acid; the montmorillonite is a polylactic acid/clay nanocomposite; referring to FIGS. 6 and 7, the montmorillonite is made up of layers of silicon oxide and aluminum oxide, in which two layers of silicon oxide tetrahedrons enclose aluminum oxide octahedrons at a dimension of 0.1μ×0.1μ1 nm, with a thickness of approximately 1 nm. The montmorillonite that exists in natural forms may has its aluminum atoms or silicon atoms substituted by other metal ions to form a basal layer with negative charge, and thus the montmorillonite absorbs cations from soil to neutralize the negative charge thereof. Subsequently, the interlayer cations may absorb water and become distributed naturally due to the effect of polarity, thus allowing lactic acid to easily exchange the sodium ions in a sodium ion-containing montmorillonite; wherein the strength of the exchange is represented as Cationic Exchange Capacity (CEC, milli-equipvalent/100 gm). Most montmorillonite have a CEC value between 130 to 180, in order to allow the hydrophilic surface of montmorillonite to react with polymer substrates like polylactic acid and polycaprolactone and give rise to nanocomposite as a result, so that the hydrophilic surface of the montmorillonite is altered to an affinitive surface; lactic acid is used as a cationic surfactant to carry out exchange of sodium ions with the surface of the montmorillonite, and the treated montmorillonite cluster in water due to the hydrophobicity of the affinitive end of the cationic surfactant, and thus resulting in a precipitation of particles with larger diameter; the surfactant may also be a polyimide/clay nanocomposite with decent mechanical strength and chemical resistance, and is used as an optimizer or filler of polymers due to its high affinity; the surfactant may also be used to optimize the structure of polymer composites in combination with inorganic materials like glass fiber, calcium carbonate, and talc powder.

By combining the aforesaid ingredients at a predetermined proportion, the resulted composite material is then subjected to heat polymerization, blow-up, and lamination to give rise to a rectangular panel with a thickness of at least 0.03 mm; the resultant rectangular panel appears as a transparent film and may be added with dyes or graphite in application to make colorful printed layers, combined with other substrates, or completely replace coatings for the substrate in order to achieve combinations of multiple colors in resultant products; the resultant rectangular panel has a mechanical flexibility of 6000 psi, is durable, and meets the general technical specification with respect to the chemistry, mechanical property, and heat-resistance of petrochemical materials; the rectangular panel is heat-resistant, resistant to radiation, dimensionally stable, has low dielectric coefficient, and does not produce a great amount of smoke when being burned. The rectangular panel may be combined as a whole with circuitry substrates, printing materials, and absorption materials to form a composite material 10 that may completely replace the petrochemistry polymers, or combined as at least one single unit with circuitry substrates, printing materials to form a composite material 20 that contains polylactic acid composite materials. Referring to FIG. 5, which shows an exemplar template for the card.

The composite material of the invention has advantages that the composite material may be easily combined with various sensor cards, smart cards, and plastic cards, which makes the application of the composite material far-reaching; the composite material may easily decompose into water and carbon dioxide in natural environments, and may be fermented and recycled so that it does not cause any environmental pollution; and the composite material is environment-friendly.

The present invention has been described with a preferred embodiment thereof and it is understood that many changes and modifications to the described embodiment can be carried out without departing from the scope and the spirit of the invention that is intended to be limited only by the appended claims.

What is claimed is:

1. An environment-friendly card, wherein a card of a predetermined thickness containing polylactic acid-containing composite material of a predetermined ratio; the card being a flexible and decomposable composite material, and being suitable for replacing petrochemistry polymers that are used to make conventional cards.

2. The environment-friendly card of claim 1, wherein the card combined with one of a circuitry substrates, a printing material, and an absorption material serves for completely replacing the petrochemistry polymers, or combined with at least one substrate containing polylactic acid composite materials.

3. The environment-friendly card of claim 1, wherein the polylactic acid-containing composite materials are used to fabricate a rectangular panel with a thickness of at least 0.03 mm; the resultant rectangular panel has a mechanical flexibility of 6000 psi, which is durable, and meets the general technical specification with respect to chemistry, mechanical property, and heat-resistance of petrochemical materials; the rectangular panel is heat-resistant, resistant to radiation, dimensionally stable, has low dielectric coefficient, and does not produce a great amount of smoke when being burned.

4. The environment-friendly card of claim 3, wherein the rectangular panel appears as a transparent film, and is added with dyes or graphite in application to make colorful printed layers, combined with other substrates, or completely replace coatings for the substrate in order to achieve combinations of multiple colors in resultant products.

5. An environment-friendly card made of decomposable materials comprising:
a main substrate being a polylactic acid resin composition extracted from plants selected from one of corn starch, sugar cane, yam, and potato, and being formed as a powder after separation, grinding, and drying processes;
an auxiliary substrate being a polycaprolactone resin and being added into the main substrate in a predetermined amount;
a surfactant being a montmorillonite added with lactic acid; the montmorillonite being a polylactic acid/clay nanocomposite, and being resulted be the hydrophilic surface of montmorillonite to react with polymer substrates like polylactic acid and polycaprolactone, so that the hydrophilic surface of the montmorillonite being altered to an affinitive surface; lactic acid being used as a cationic surfactant to carry out exchange of sodium ions with a surface of the montmorillonite, and the treated montmorillonite cluster in water due to the hydrophobicity of the affinitive end of the cationic surfactant, and thus resulting in a precipitation of particles with larger diameter; the surfactant being a polyimide/clay nanocomposite with decent mechanical strength and chemical resistance, and being used as an optimizer or filler of polymers due to its high affinity; the surfactant being used to optimize a structure of polymer composite materials in combination with inorganic materials like glass fiber, calcium carbonate, and talc powder.

6. The environment-friendly card of claim 5, wherein the composition of the main substrate comprises particles of approximately 5-10 nm in diameter.

7. The environment-friendly card of claim 5, wherein the surfactant is polylactic acid/clay nanocomposite comprising montmorillonite made up of layers of silicon oxide and aluminum oxide, in which two layers of silicon oxide tetrahedrons enclose aluminum oxide octahedrons at a dimension of 0.1 μ×0.1μ×1 nm, with a thickness of approximately 1 nm.

8. The environment-friendly card of claim 5, wherein a CEC value of most of the montmorillonite is approximately between 130-180.
